(19) United States
(12) Patent Application Publication
(10) Pub. No.: US 2008/0164306 A1
(43) Pub. Date: Jul. 10, 2008

(54) Systems and methods for storing banking transaction information

(76) Inventor: George Gu, Agoura Hills, CA (US)

Correspondence Address: SMITH FROHWEIN TEMPEL GREENLEE BLAHA, LLC, Two Ravinia Drive, Suite 700, ATLANTA, GA, 30346, US

(21) Appl. No.: 11/651,280

(22) Filed: Jan. 9, 2007

(51) Int. Cl. G06F 17/00

(52) U.S. Cl. 235/379

(57) ABSTRACT

A method for storing banking transaction information, includes: entering, by a first bank teller, first banking transaction information corresponding to a first bank customer into a first bank teller computer; storing the first banking transaction information at the first bank teller computer; transmitting the first banking transaction information from the first bank teller computer to a second bank teller computer that is used by a second bank teller; and storing the first banking transaction information at the second bank teller computer.

### BACKGROUND

Bank tellers enter banking transaction information into their computers while processing transactions for bank customers. The transaction information is often stored at the bank teller computer as well as being transmitted to a remotely located server. However, when communication between the bank teller and the bank server fails (e.g., due to a malfunction in the bank teller computer, the bank server, and/or the communication network), then banking transaction information entered during the communication failure is not transmitted to the bank server. As a result, if the hard-drive of the bank teller computer crashes, then valuable banking transaction information is lost. Therefore, there exists a need to address this problem associated with banking transactions.

### SUMMARY

Embodiments of the present invention provide systems and methods for storing banking transaction information. An embodiment, among others, of a method for storing banking transaction information includes: entering, by a first bank teller, first banking transaction information corresponding to a first bank customer into a first bank teller computer; storing the first banking transaction information at the first bank teller computer; transmitting the first banking transaction information from the first bank teller computer to a second bank teller computer that is used by a second bank teller; and storing the first banking transaction information at the second bank teller computer.

An embodiment of a system for storing banking transaction information includes: a first bank teller computer having stored therein first banking transaction information entered into the first bank teller computer by a first bank teller, wherein the first banking transaction information corresponds to a first bank customer; and a second bank teller computer having stored therein the first banking transaction information entered into the first bank teller computer by the first bank teller; wherein the first banking transaction information is transmitted from the first bank teller computer to the second bank teller computer.

An embodiment of another system for storing banking transaction information includes: means for entering, by a first bank teller, first banking transaction information corresponding to a first bank customer into a first bank teller computer; means for storing the first banking transaction information at the first bank teller computer; means for transmitting the first banking transaction information from the first bank teller computer to a second bank teller computer that is used by a second bank teller; and means for storing the first banking transaction information at the second bank teller computer, wherein the first banking transaction information is stored at the first and second bank teller computers.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a block diagram depicting an embodiment of a banking transaction system.

FIG. 2 is a flow chart depicting an embodiment of a method for storing banking transaction information.

FIGS. 3A and 3B are flow charts depicting respective embodiments of methods for transmitting banking transaction information.

FIG. 4 is a flow chart depicting an embodiment of a method for storing and transmitting banking transaction information.

FIGS. 5 and 6 are block diagrams illustrating respective embodiments of bank teller computers.

FIG. 7 is a block diagram depicting another embodiment of a teller computer.

FIG. 8 is a flow chart depicting an embodiment of a method for retrieving banking transaction information.

FIG. 9 is a flow chart depicting an embodiment of a method for storing banking transaction information in a peer-to-peer network.

### DETAILED DESCRIPTION

According to one embodiment, a plurality of bank teller computers located at a branch of a bank are communicatively coupled. Peer to peer technology enables a bank teller to store customer transaction information on computers being used by one or more other bank tellers. As a result, if banking transaction information is not retrievable from a first bank teller computer, it can be recovered from another bank teller computer. The number of bank teller computers where the copies of transaction information is to be stored are configurable, as is the manner in which the information is stored. Storing copies of transaction information at a plurality of bank teller computers is especially useful when communication between a bank teller computer and a remote server (that would normally store a copy of bank teller transactions) is disrupted.

A recovery mechanism can recover banking transaction information from one or more bank teller computers and reconstruct or augment a database of customer transaction information. The banking transaction information is retrieved via a local bank computer and/or by a remotely located computer (e.g., a server).

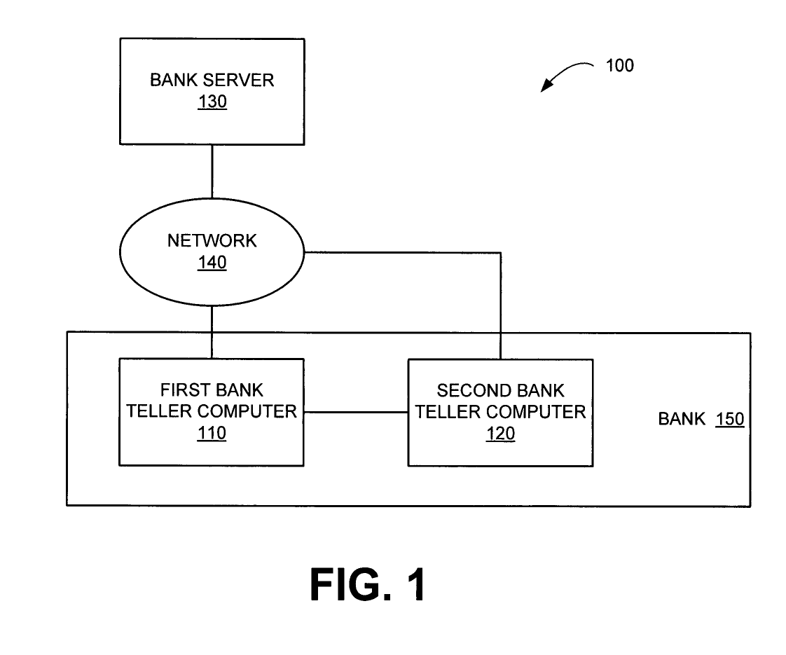

Referring now to the figures, FIG. 1 is a block diagram depicting an embodiment of a banking transaction system 100. The system 100 includes a first bank teller computer 110 and a second bank teller computer 120 that are located at a bank 150. The first bank teller computer 110 is coupled to the second bank teller computer 120 via a wireless or wired network (e.g., Ethernet). The first bank teller computer 110 and the second bank teller computer 120 are coupled to a bank server 130 via a network 140. The network 140 is, for example, a wide area network (WAN) or the Internet. A first bank teller uses the first bank teller computer 110 to enter banking transaction information (e.g., information corresponding to bank customers that visit the bank to conduct banking transactions). Similarly, a second bank teller uses the second bank teller computer 120 to enter banking transaction information. Examples, among others, of banking transaction information that is entered into the first bank teller computer 110 and/or the second bank teller computer 120 include information about fund (check and cash) deposits and withdrawals, purchases of cashier's checks, and/or purchases of foreign currency, among others.

Transaction information entered into the first bank teller computer 110 is stored in non-volatile memory in the first bank teller computer 110 as well as in non-volatile memory in the second bank teller computer 120 (e.g., after the transaction information is transmitted from the first bank teller computer 110 to the second bank teller computer 120). In this manner, if the first bank teller computer 110 malfunctions, then transaction information entered by a bank teller into the first bank teller computer 110 is retrieved from the second bank teller computer 120 (e.g., by the bank server 130 or by another computer located at the bank 150). This is especially useful where the transaction information had not yet been provided to the bank server 130 (e.g., due to a communication problem between the first bank teller computer 110 and the bank server 130 and/or due to a malfunction of the bank server 130).

The transaction information is provided by the second bank teller computer 120 to the bank server 130 using push and/or pull transmission mechanisms (i.e., responsive to a request for the information and/or without a prior request for the information). The bank server 130 uses the banking transaction information received from the second bank teller computer 120 to reconstruct or augment a database of banking transaction information.

When communication between the first bank teller computer 110 and the bank server 130 is interrupted, then the first bank teller using the first bank teller computer 110 provides limited banking services to customers. For example, although the first bank teller accepts all types of deposits normally accepted when communication with the bank server 130 is functional, the first bank teller is prohibited from cashing checks or providing withdrawals that are in excess of a predetermined amount (e.g., $100) when communication with the bank server 130 is disrupted.

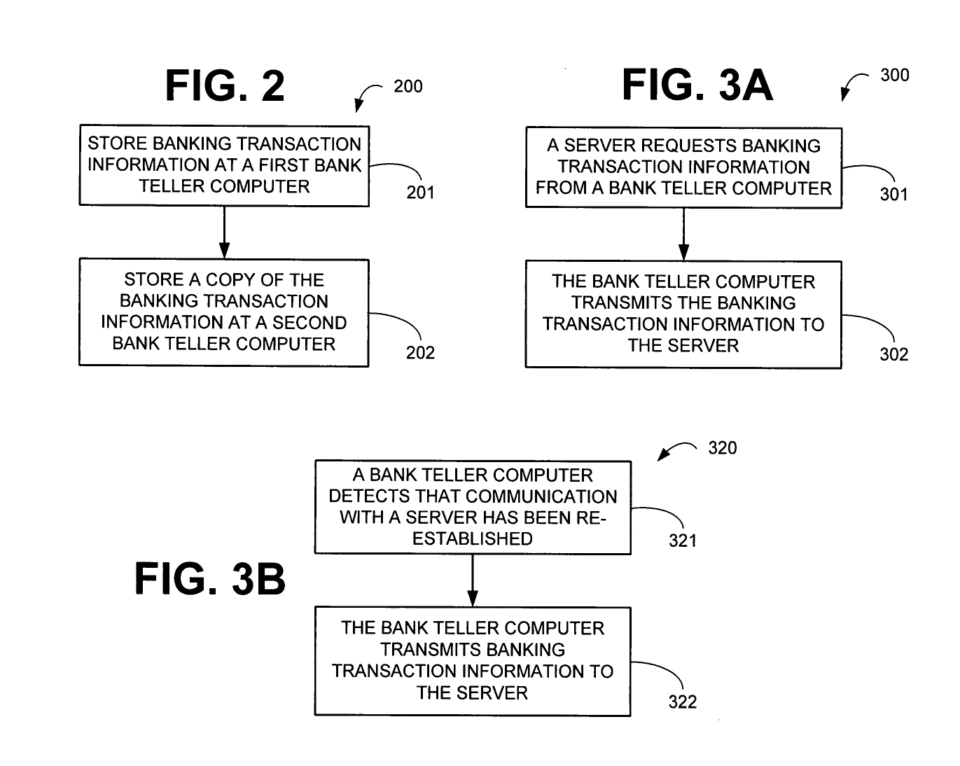

FIG. 2 is a flow chart depicting an embodiment of a method 200 for storing banking transaction information. According to step 201, banking transaction information is stored at a first bank teller computer 110 (FIG. 1) used by a first bank teller. The banking transaction information includes, for example, information regarding the deposit and/or withdrawal of funds into respective customer accounts. A copy of the banking transaction information is also stored at a second bank teller computer 120 (FIG. 1) used by a second bank teller, as indicated in step 202. Storing a copy of the banking transaction information at the second bank teller computer 120 serves as a backup in case the first bank teller computer 110 experiences failure. If the first bank teller does experience failure then banking transaction information entered into the first bank teller computer 110 is retrieved from the second bank teller computer 120 (e.g., by a remotely located server).

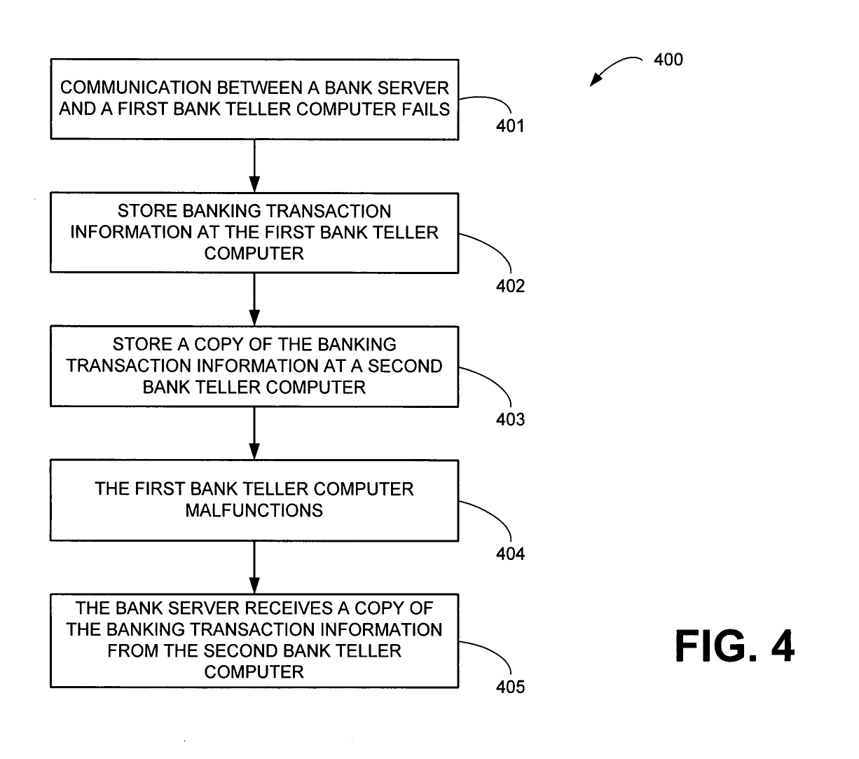

FIG. 3A is a flow chart depicting an embodiment of a method 300 for transmitting banking transaction information. According to step 301, a bank server 130 (FIG. 1) requests banking transaction information from a bank teller computer 120 (FIG. 1). Then, responsive to the bank server 130 request, the bank teller computer 120 transmits the banking transaction information to the bank server 130, as indicated in step 302. In another embodiment, the bank teller computer 120, for example, transmits the banking transaction information to the bank server 130 without having received a specific request for the information from the bank server 130. The banking transaction information transmitted by the bank teller computer is a backup copy of banking transaction information that was entered by a bank teller into another bank teller computer 110.

FIG. 3B is a flow chart depicting an embodiment of a method 320 for transmitting banking transaction information. According to step 321, a bank teller computer 120 (FIG. 1) detects that communication with a bank server 130 (FIG. 1) has been reestablished (e.g., after a period of interrupted communication between the bank teller computer 120 and the bank server 130). Then, responsive detecting that communication with the bank server 130 has been re-established, the bank teller computer transmits banking transaction information to the bank server 130, as indicated in step 322. The banking transaction information transmitted by the bank teller computer is a backup copy of banking transaction information that was entered by a bank teller into another bank teller computer 110 (FIG. 1).

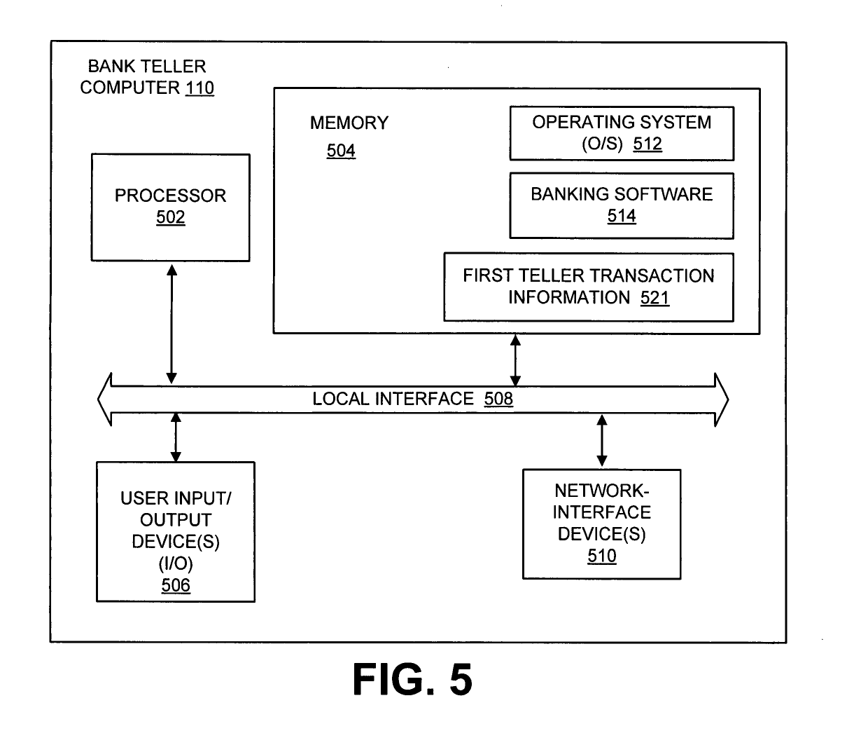

FIG. 4 is a flow chart depicting an embodiment of a method 400 for storing and transmitting banking transaction information. According to step 401, communication between a bank server 130 (FIG. 1) and a first bank teller computer 110 fails. This failure in communication is due to malfunction in the bank server 130, a malfunction in the first bank teller computer 110, and/or a malfunction in a communication network 140 that couples the bank server 130 and the first bank teller computer 110. Banking transaction information is then stored at the first bank teller computer 110, as indicated in step 402. The banking transaction information corresponds to banking transactions that are entered by a first bank teller into the first bank teller computer 110. A copy of the banking transaction information is stored at a second bank teller computer 120 (that is used by a second bank teller), as indicated in step 403 (e.g., after being received from the first bank teller computer 110). The first bank teller computer 110 then malfunctions, as indicated in step 404. The malfunction is, for example, a hardware and/or software malfunction. The bank server 130 then receives a copy of the banking transaction information from the second bank teller computer 120, as indicated in step 405. The banking transaction is provided to the bank server 130 upon request and/or without a specific request for the information. The banking transaction information is alternatively or additionally retrieved by a bank teller or agent at the bank where the first and second bank teller computers 120 are located.

Any process descriptions or blocks in flow charts should be understood to represent modules, segments, or portions of code, which include one or more executable instructions for implementing specific logical functions or steps in the process. Alternative implementations are included within the scope of the embodiments of the invention in which functions are executed out of order from that shown or discussed, including substantially concurrently or in reverse order, depending on the functionality involved, as would be understood by those reasonably skilled in the art of the present invention.

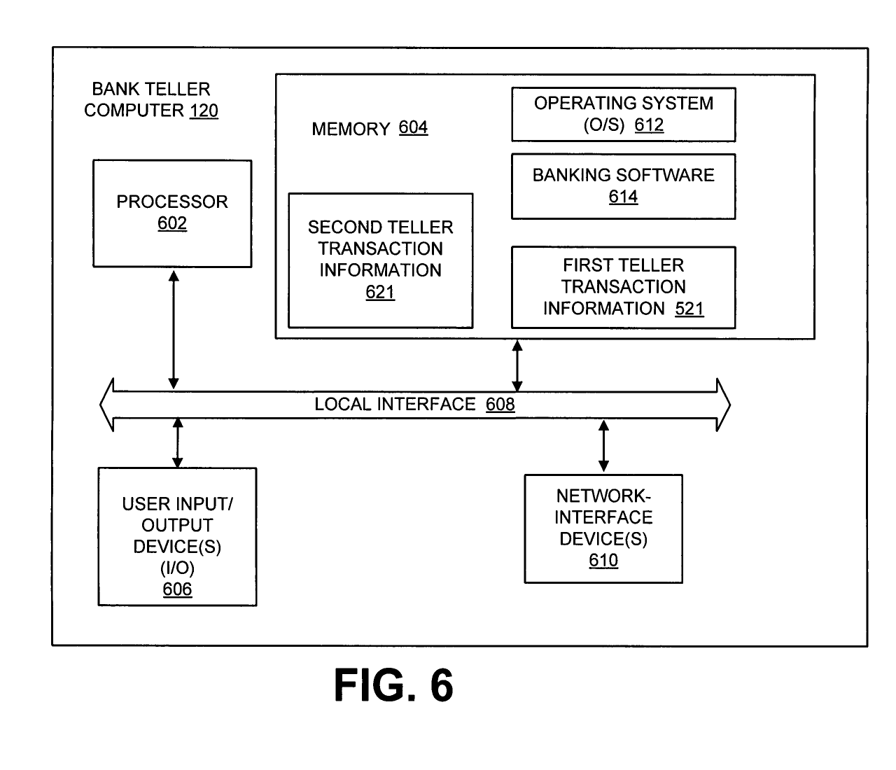

FIG. 5 is a block diagram illustrating an embodiment of a first bank teller computer 110 that is used by a first bank teller. The bank teller computer 110 includes a processor 502, memory 504 and user input and/or output (I/O) devices 506 (or peripherals) that are communicatively coupled via a local interface 508.

The local interface 508 includes, for example, but not limited to, one or more buses and/or other wired or wireless connections, as is known in the art. The local interface 508 has additional elements, which are omitted for simplicity, such as controllers, buffers (caches), drivers, repeaters, and/or receivers, to enable communications. Further, the local interface 508 includes address, control, and/or data connections to enable appropriate communications among the aforementioned components.

The processor 502 is a hardware device for executing software, particularly that stored in memory 504. The processor 502 can be any custom made or commercially available processor, a central processing unit (CPU), an auxiliary processor among several processors associated with the underwriter system, a semiconductor based microprocessor (in the form of a microchip or chip set), or generally any device for executing software instructions.

The memory 504 can include any one or combination of volatile memory elements (e.g., RAM, such as DRAM, SRAM, SDRAM, etc.) and nonvolatile memory elements (e.g., ROM, flash memory, etc.). Moreover, the memory 504 may incorporate electronic, magnetic, optical, and/or other types of storage media. Note that the memory 504 can have a distributed architecture, where various components are situated remote from one another, but accessible via the processor 502.

The user I/O device(s) 506 include input devices, for example, but not limited to, a keyboard, mouse, scanner, microphone, a touch sensitive display, etc. Furthermore, the user I/O device(s) 506 include output devices, for example but not limited to, a printer, display, etc. The network-interface device(s) 510 include, for example, a modem, a radio frequency (RF) or other transceiver, a telephonic interface, a bridge, a router, and/or an Ethernet interface. The network-interface device(s) 510 couple the bank teller computer 110 to a local (i.e., bank branch) network and/or to the network 140 (FIG. 1).

Software stored in memory 504 includes one or more separate programs, each one of which comprises an ordered listing of executable instructions for implementing logical functions. In the example of FIG. 5, the software in the memory 504 includes operating system 512 and banking software 514. Among other things, operating system 512 essentially controls the execution of the banking software 514 and provides scheduling, input-output control, file and data management, memory management, and communication control and related services. The memory 504 also includes first teller transaction information 521 corresponding to banking transaction information entered into the first computer 110 by the first bank teller. The banking software 514 transmits a copy of the first teller transaction information 521 to the banking software 544 (FIG. 5B) which then stores the copy of the first teller transaction information 521 at the bank teller computer 120.

The banking software 514 is a source program, executable program (object code), script, or any other entity comprising a set of instructions to be performed. When implemented as a source program, the banking software 514 is translated via a compiler, assembler, interpreter, or the like, which may or may not be included within the memory 504, so as to operate properly in connection with the O/S 512. Furthermore, the banking software 514 can be written in one or more object oriented programming languages, which have classes of data and methods, or procedure programming languages, which have routines, subroutines, and/or functions.

FIG. 6 is a block diagram illustrating an embodiment of a second bank teller computer 120 that is used by a second bank teller. The bank teller computer 120 includes a processor 602, memory 604 and user input and/or output (I/O) devices 606 (or peripherals) that are communicatively coupled via a local interface 608.

The local interface 608 includes, for example, but not limited to, one or more buses and/or other wired or wireless connections, as is known in the art. The local interface 608 has additional elements, which are omitted for simplicity, such as controllers, buffers (caches), drivers, repeaters, and/or receivers, to enable communications. Further, the local interface 608 includes address, control, and/or data connections to enable appropriate communications among the aforementioned components.

The processor 602 is a hardware device for executing software, particularly that stored in memory 604. The processor 602 can be any custom made or commercially available processor, a central processing unit (CPU), an auxiliary processor among several processors associated with the underwriter system, a semiconductor based microprocessor (in the form of a microchip or chip set), or generally any device for executing software instructions.

The memory 604 can include any one or combination of volatile memory elements (e.g., RAM, such as DRAM, SRAM, SDRAM, etc.) and nonvolatile memory elements (e.g., ROM, flash memory, etc.). Moreover, the memory 604 may incorporate electronic, magnetic, optical, and/or other types of storage media. Note that the memory 604 can have a distributed architecture, where various components are situated remote from one another, but accessible via the processor 602.

The user I/O device(s) 606 include input devices, for example, but not limited to, a keyboard, mouse, scanner, microphone, a touch sensitive display, etc. Furthermore, the user I/O device(s) 606 include output devices, for example but not limited to, a printer, display, etc. The network-interface device(s) 610 include, for example, a modem, a radio frequency (RF) or other transceiver, a telephonic interface, a bridge, a router, and/or an Ethernet interface. The network-interface device(s) 610 couple the bank teller computer 120 to a local (i.e., bank branch) network and/or to the network 140 (FIG. 1).

Software stored in memory 604 includes one or more separate programs, each one of which comprises an ordered listing of executable instructions for implementing logical functions. In the example of FIG. 6, the software in the memory 604 includes operating system 612 and banking software 614. Among other things, operating system 612 essentially controls the execution of the banking software 614 and provides scheduling, input-output control, file and data management, memory management, and communication control and related services.

The memory 604 also includes first teller transaction information 521 corresponding to banking transaction information entered by a first bank teller into the first bank teller computer 110, as well as second teller transaction information 621 corresponding to banking transaction information entered into the second bank teller computer 120 by a second bank teller. The banking software 614 receives the first teller transaction information 521 from the banking software 514 and stores it into the memory 604.

The banking software 614 is a source program, executable program (object code), script, or any other entity comprising a set of instructions to be performed. When implemented as a source program, the banking software 614 is translated via a compiler, assembler, interpreter, or the like, which may or may not be included within the memory 604, so as to operate properly in connection with the O/S 612. Furthermore, the banking software 614 can be written in one or more object oriented programming languages, which have classes of data and methods, or procedure programming languages, which have routines, subroutines, and/or functions.

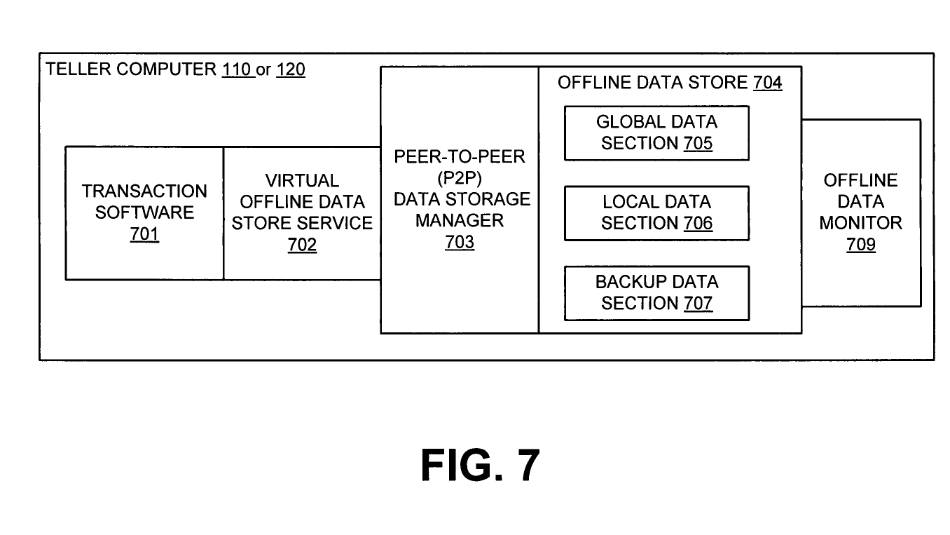

FIG. 7 is a block diagram depicting an embodiment of a teller computer 110 or 120. The teller computer 110 or 120 includes transaction software 701, a virtual offline data store service 702, a peer-to-peer (P2P) data storage manager 703, an offline data store 704, and an offline data monitor 709. The transaction software 701 is configured to process bank transactions. The P2P data storage manager 703 is configured to manage the storage of transaction data, including storing and retrieving data from the offline data store 704. The virtual offline data store service 702 is configured to interface between the transaction software 701 and the P2P data storage manager 703. For example, the virtual offline data store service 702 receives a request for transaction data from the transaction software 701 and forwards the request to the P2P data storage manager 703. The offline data monitor 709 monitors the time since portions of data stored in the offline data store 704 have last been updated.

The offline data store 704 includes a global data section 705, a local data section 706, and a backup data section 707. The global data section 705 is used to store read-only properties/settings (e.g., foreign currency exchange rate, security entitlement settings, etc.) for a corresponding teller computer 110 or 120. The local data section 706 is used to store transaction data and settings for a corresponding teller computer 110 or 120. The backup data section 707 is used to store copies of data stored in the global data section 705 and/or the local data section 706 of a corresponding teller computer 110 or 120 and/or of other teller computers.

The offline data for a teller computer 110 or 120 is managed by the P2P data storage manager 703. The P2P network in the financial institution branch forms a unified but distributed data store, which can include backup data to increase data availability. The location of the data is transparent to the transaction software 701. Banks can adopt different P2P data backup policies to enhance the performance, reliability and data availability.

The P2P data storage manager 703 uses a distributed hash table (DHT) that describes the data managed by the P2P data store manager 703. Each portion of the data in the offline store has an entry in the DHT. For example, each bank transaction corresponding to each teller using a teller computer 110 or 120 has an entry in the DHT that describes the transaction. The DHT serves as a catalog of the data in the P2P network. By checking the DHT, the P2P data storage manager 703 can determine where to find the data, whether the data available locally, the last update time of the data, how many peers exist, etc. Each P2P data storage manager 703 is responsible for updating the DHT.

When a client workstation is activated, the P2P data storage manager 703 joins the P2P network and joins the DHT by broadcasting DHT information so the data under its management becomes available to other peers. When a teller computer is turned off, the P2P data storage manager 703 leaves the P2P network and the DHT. Based on a predetermined policy, the P2P data storage manager 703 may transfer its portion of data to other peers before it leaves the P2P network.

Consider a scenario where a teller moves from using the teller computer 110 to using the teller computer 120. If the teller then uses teller computer 120 to request transaction data corresponding to transactions implemented via teller computer 110, the P2P data storage manager 703 of the teller computer 120 searches the DHT, finds the location of the data that is stored in the teller computer 110 and retrieves the data from the teller computer 110. The copy of the retrieved data is then saved in the local data section 706 of teller computer 120. The P2P data storage manger 703 also updates the DHT to reflect the fact that a copy of the data is stored at teller computer 120. In this manner, the next time a teller using the teller computer 120 requests the data, it can be retrieved by the teller computer 120 from the local data section 706 of the teller computer 120. If transaction data is changed during a transaction, then all the copies of the data in the P2P network can be updated by broadcasting a copy of the changed data in the P2P network.

Some data in the offline data store 704 is assigned a time-to-live (TTL) period beyond which the data is no longer valid. Managing the aging data is done by the offline data monitor 709. The offline data monitor 709 uses a timer to monitor the data. If no update to the data occurs within a predetermined timer period (e.g., based on updated data received from the server 130 or from other teller computers) the offline data monitor 709 calls the P2P data storage manager 703 to check if an update is needed. The P2P data storage manager 703 uses the DHT to determine if updates are available from other teller computers. If the corresponding data in the P2P network is out of date, then the P2P data storage manager 703 gets updated data from the bank server 130 (FIG. 1). After getting the updated data from the bank server 130, then the P2P data storage manager 703 updates the DHT with a new time stamp for the updated data.

When P2P data storage manager 703 contacts the server 130 to check for an update, the P2P data storage manager 703 provides the last update time stamp to the server 130. The server 130 uses the time stamp as a database searching criteria and returns all the data that has been updated within a predetermined time from the time stamp. If no changes have been made to the data within the predetermined time, the server 130 returns, for example, an empty set to the P2P data storage manager 703.

If a network connection between a teller computer 110 or 120 and the bank server 103 has been disconnected for a significant timer period, then some of the data in the offline data store of the respective computer will expire. When the network connection is restored, the P2P data storage manager 703 queries the server 130 to determine if there are newer versions of local data available. If newer versions are available, then the P2P data storage manager 703 receives the newer versions of the data from the server 130 and updates the offline data store 704 accordingly. Furthermore, if there are new or newer transaction data that is stored in the offline data store 704 (i.e., newer than corresponding data in the server 130), then the P2P data storage manager 703 transmits a copy of the new or newer transaction data to the server 130 where it is stored and/or processed accordingly.

For data that is identical for all teller computers (e.g., exchange rate settings), only one teller computer will retrieve such data from the application server 130 (FIG. 1). Other teller computers can then get a copy of such data from the teller computer that retrieved the data from the server 130. For example, a teller computer 110 or 120 can broadcast a copy of data received from the server 130 to other teller computers. This approach can significantly reduce network traffic between teller computers 110 and 120 and the bank server 130.

Banks can select a P2P backup strategy for selected portions of the data. The policy can define, for example, the number of copies of certain data and where such copies are stored. When certain data is configured to be backed-up in the P2P network, then each time the data is saved to the offline data store 704 of a corresponding teller computer, the P2P data storage manager 703 broadcasts a copy of the data to other teller computers. In this manner, when a teller computer experiences a hard-drive crash, a copy of the data can be retrieved from another teller computer.

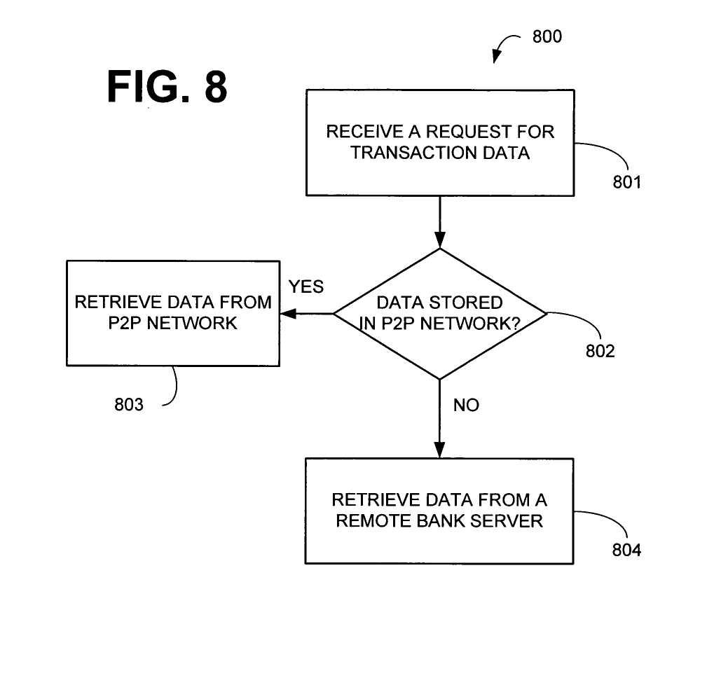

FIG. 8 is a flow chart depicting a method 800 for retrieving transaction data. The method 800 is implemented by, for example, a P2P data storage manager 703 (FIG. 7) of the first teller computer 110 or the second teller computer 120. According to step 801, a request for transaction data is received (e.g., by the P2P data storage manager 703). The request is initiated by, for example, the transaction software 701 (FIG. 7). Responsive to receiving the request for transaction data, a determination is made as to whether the requested data is stored in the local P2P network, as indicated in step 802. If the requested data is stored in the P2P network, then the data is retrieved from the P2P network, as indicated in step 803. For example, the data is retrieved from the offline data store 704 of the teller computer making the determination in step 802 or from the offline data store 704 of another teller computer that is part of the P2P network. If the data is not stored in the P2P network, then the data is retrieved from a remote bank server (e.g., the bank server 130 shown in FIG. 1), as indicated in step 804.

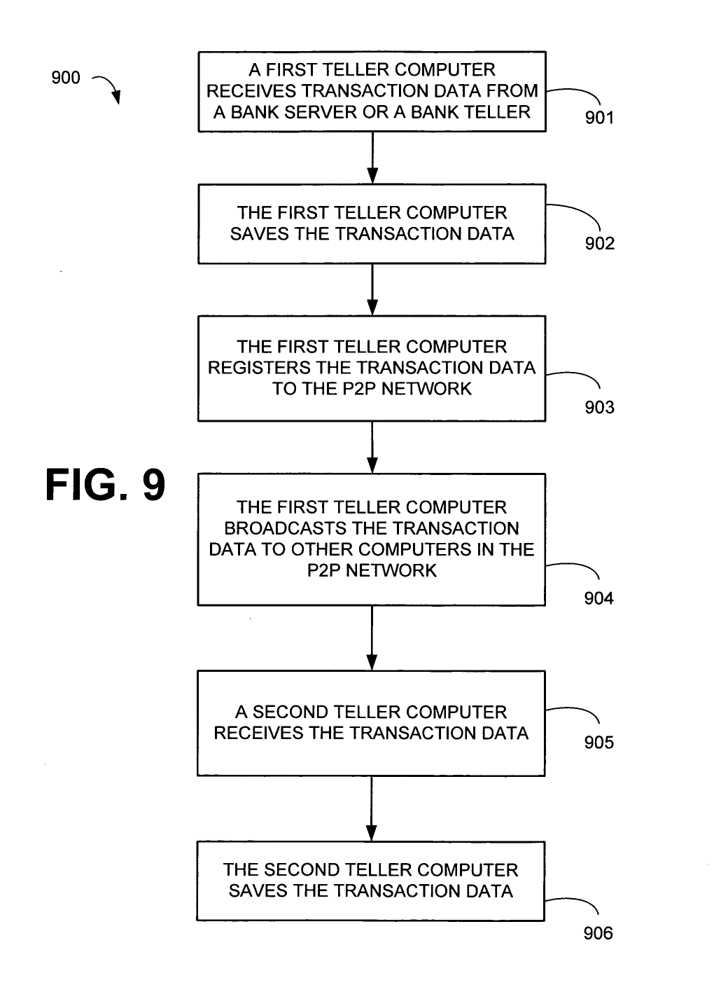

FIG. 9 is a flow chart depicting a method 900 for saving transaction data. As indicated in step 901, a first teller computer 110 receives transaction data from a bank server 130 (FIG. 1) or a bank teller. The data is received, for example, by the P2P data storage manager 703 (FIG. 7) of the first teller computer 110. After receiving the transaction data, the first teller computer 110 saves the transaction data, as indicated in step 902. The transaction data is saved by, for example, the P2P data storage manager 703 in the local data section 706 (FIG. 7) of the first teller computer 110.

After storing the transaction data, the first teller computer 110 registers the transaction data to the P2P network, as indicated in step 903. The registration is performed by, for example, the P2P data storage manager 703 of the first teller computer 110. After registering the transaction data, the first teller computer 110 broadcasts the transaction data to other computers in the P2P network, as indicated in step 904. The broadcasting of the data is performed, for example, by the P2P data storage manager 703 of the first teller computer 110.

After the transaction data is broadcast by the first teller computer 110, a second teller computer 120 receives the transaction data, as indicated in step 905. The transaction data is received, for example, by the P2P data storage manager 703 (FIG. 7) of the second teller computer 120. After receiving the transaction data, the second teller computer 120 saves the transaction data, as indicated in step 906. The transaction data is saved by, for example, the P2P data storage manager 703 in the backup data section 707 (FIG. 7) of the second teller computer 120. As a result, the transaction data is available to other teller computers via the second teller computer 120 in case the first teller computer 110, the network 140 and/or the bank server 130 malfunction.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

1. A method for storing banking transaction information, comprising:
entering, by a first bank teller, first banking transaction information corresponding to a first bank customer into a first bank teller computer;
storing the first banking transaction information at the first bank teller computer;
transmitting the first banking transaction information from the first bank teller computer to a second bank teller computer that is used by a second bank teller; and
storing the first banking transaction information at the second bank teller computer.

2. The method of claim 1, further comprising entering, by the second bank teller, second banking transaction information corresponding to a second bank customer into the second bank teller computer.

3. The method of claim 2, further comprising storing the second banking transaction information at the first bank teller computer and at the second bank teller computer.

4. The method of claim 1, further comprising transmitting the first banking transaction information by the second bank teller computer to a remotely located server.

5. The method of claim 1, further comprising transmitting the first banking transaction information by the first bank teller computer to a remotely located server.

6. The method of claim 1, further comprising determining that communication between the first bank teller computer and a remotely located server has been disrupted.

7. The method of claim 1, further comprising transmitting the first banking transaction information from the second bank teller computer to a third computer located at the same premises as the second bank teller computer.

8. The method of claim 1, further comprising storing the first banking transaction information at more than two bank teller computers.

9. A system for storing banking transaction information, comprising:
a first bank teller computer having stored therein first banking transaction information entered into the first bank teller computer by a first bank teller, wherein the first banking transaction information corresponds to a first bank customer; and
a second bank teller computer having stored therein the first banking transaction information entered into the first bank teller computer by the first bank teller; wherein the first banking transaction information is transmitted from the first bank teller computer to the second bank teller computer.

10. The system of claim 9, wherein the second bank teller enters second banking transaction information corresponding to a second bank customer into the second bank teller computer.

11. The system of claim 10, wherein the second banking transaction information is stored at the first bank teller computer and at the second bank teller computer.

12. The system of claim 9, further comprising a remotely located server that receives the first banking transaction information from the second bank teller computer.

13. The system of claim 9, further comprising a remotely located server that receives the first banking transaction information from the first bank teller computer.

14. The system of claim 9, further comprising a third computer located at the same premises as the second bank teller computer, wherein the third computer receives the first banking transaction information from the second bank teller computer.

15. A system for storing banking transaction information, comprising:
means for entering, by a first bank teller, first banking transaction information corresponding to a first bank customer into a first bank teller computer;
means for storing the first banking transaction information at the first bank teller computer;
means for transmitting the first banking transaction information from the first bank teller computer to a second bank teller computer that is used by a second bank teller; and
means for storing the first banking transaction information at the second bank teller computer, wherein the first banking transaction information is stored at the first and second bank teller computers.

16. The system of claim 15, wherein the second bank teller enters second banking transaction information corresponding to a second bank customer into the second bank teller computer.

17. The system of claim 16, wherein the second banking transaction information is stored at the first bank teller computer and at the second bank teller computer.

18. The system of claim 15, further comprising a remotely located server that receives the first banking transaction information from the second bank teller computer.

19. The system of claim 15, further comprising a remotely located server that receives the first banking transaction information from the first bank teller computer.

20. The system of claim 15, further comprising a third computer located at the same premises as the second bank teller computer, wherein the third computer receives the first banking transaction information from the second bank teller computer.
